(19) United States
(12) Patent Application Publication
(10) Pub. No.: US 2023/0365069 A1
(43) Pub. Date: Nov. 16, 2023

(54) UNIVERSAL BLIND SPOT DETECTION SYSTEM

(71) Applicant: Rydeen North America Inc, Torrance, CA (US)

(72) Inventor: PHILIP MAEDA, TORRANCE, CA (US)

(73) Assignee: Rydeen North America Inc., Torrance, CA (US)

(21) Appl. No.: 17/663,646

(22) Filed: May 16, 2022

(51) Int. Cl. B60R 11/00; B60Q 1/00; B60R 16/03; B60R 11/04

(52) U.S. Cl. CPC B60R 11/00; B60Q 1/0023; B60R 16/03; B60R 11/04; B60R 2011/004

(57) ABSTRACT

A blind spot detection system mounted to a trailer hitch in a in one embodiment, to a license plate frame in a second embodiment and to the third brake light of a commercial vehicle in a third embodiment.

### BACKGROUND OF THE INVENTION

### 1. Field of the Invention

The present invention relates to a vehicle safety system for the detection of vehicles and objects in the common blind spot of the driver's vision.

### 2. Description of the Prior Art

The blind spot of a vehicle is typically an area that is not in the drivers view and not covered by traditional mirrors in the vehicle. When changing lanes, an approaching vehicle from the rear at higher speeds or a vehicle at the same speed can often not be seen as the views offered by the traditional mirrors in the vehicle which are inadequate to cover these areas. They are often blocked by the frame or solid area of the approaching vehicle and do not have the coverage area needed to offer a safe view when changing lanes. Blind spot detection systems of many types have been developed to assist the driver in these situations offering a signal of some type when it is unsafe to make a lane change. Systems like these works very well when installed in a vehicle at the time of manufacture as optimal areas can be chosen for the mounting of such sensors that can be predetermined when the vehicle is being designed.

Automotive blind spot detection systems have been commercially available for some time. They are typically installed at the time of the vehicle manufacturing and are part of an overall safety system. For years the aftermarket has been trying to develop systems that can be added to existing vehicles to perform this task. Many types of systems have been developed but they all have limitations and perform poorly making these systems virtually useless in the prevention of accidents. If the systems are not working at 100%, they are often ignored by the drivers as the information they provide is perceived as useless.

Some of these systems utilize ultrasonic-sensing techniques that require small ultrasonic sensors to be fit it in the rear and side of the vehicle. These sensors must be installed by drilling large holes in the rear side panels for the mounting of at least two sensors, one per side, exact locations behind the rear wheels of the vehicle. These sensors use ultrasonic radio waves that transmit out only a few feet from the vehicle and they had several problems:
They are sensitive to rain and moisture that will cause them to not operate.
They can be covered by snow or mud in adverse driving conditions and will not operate.
They require large holes to be cut in the vehicle that leaves the vehicle at risk of leaking and rust.
They must be color coded to the vehicle to match the finish that involves painting and color-matching of the sensors themselves.
They will not operate effectively when mounted in metal of any kind.
They have a very limited range typically 1-6 ft. that is not sufficient for this type of detection.

Radar or high frequency systems, called microwave and millimeter band that operate between 1 and 120 GHz, are the most accurate and do not suffer from the limitations of the ultrasonic based systems. The systems have been adopted as the standard type of systems for all original equipment manufacturers in the design of their vehicles. Their sensing range is far superior, exceeding 80-feet and offer cross traffic detection when leaving a parking space. The systems are not adversely affected by wind, rain, snow, dirt or mud making them vastly better for vehicle use. The systems are generally installed when building the vehicle and can be placed in a manner that will complement their operation. Though these systems work very well, when installed by the factory, they are often very hard, or impossible to install after the vehicle has been manufactured. They require removal of body panels and complex wiring in areas not available when the vehicle has already been put together. Radar systems are also limited; although their signal can penetrate plastics of many kinds, they cannot penetrate metal making them impossible to install in vehicles like work trucks or vans that often can benefit most from the installation of these systems.

What is desired is to provide a vehicle blind spot system that overcomes the obstacles noted hereinabove thus making them, ideal for any vehicle including commercial vehicles that are equipped with metal panels and bumpers.

### SUMMARY OF THE INVENTION

The present invention relates to vehicles that have not been manufactured with the OEM systems noted hereinabove but rather can be fitted to the vehicle after initial manufacturing has been completed. The system utilizes an advanced radiofrequency system that accurately detects vehicles and objects within the blind spot that can be installed after the vehicle is manufactured in a way that is both effective and easy to install, providing original equipment protection in a manufactured vehicle not equipped with the system. The system utilizes high frequency radio waves to detect vehicles or objects within the blind spot and is built in a way to minimise the time and expertise needed to install the system. This approach requires little knowledge to complete an installation and can be used in any vehicle. By means of wireless transmission and simplified installation it can even be used as a do-it-yourself installation (“DIY”) that would make the system readily available to all drivers and in so doing, making driving safer and potentially saving lives.

The present invention provides a high frequency or radar-based system that is a self-contained, all in one, for accurate blind spot detection. This system has few major components that when operated together form an easy to install and accurate form of blind spot detection that can be used in any vehicle.

The first embodiment of the invention is adapted for use with trucks and commercial vehicles that are equipped with a conventional tow hitch. These tow hitches are common on larger vehicles such as truck and work vehicles but can also be added to any vehicle for towing of large or small items. With this arrangement, the sensors will be located at the absolute rear of the vehicle in a position that is not obstructed by any part of the vehicle.

The first component of the system is a high frequency or radar-based configuration that is purposely built on a male receptacle that fits to an existing tow hitch. These are typically square and are of a standard size making them universal in most cases or very adaptable with small inserts or spacers. The system has one or two sensors placed in a manner that provides the best coverage for blind spot detection. Since these sensors are already mounted and accurately placed for optimum sensing angle, they can be mounted very quickly by being inserted in the tow hitch receptacle with or without step structure. These offer many benefits as the sensors are already installed at the correct placement angle, they are prewired to a control interface within the mounting structure, and they are beyond the potentially interfering body parts of the vehicle. The installation would just be putting the pre-built structure into the trailer receptacle. A control module within that structure will process the information received from the sensors by way of a specifically designed processor and the unit can transmit this information wirelessly to a second module located within the vehicle. The secure connection relays that information to the driver by visual and/or audible means.

The exterior control unit containing the sensors and processor can also house a camera that can aid when the vehicle is in reverse or provide useful information to the driver if needed. Not limited to radar sensors used for blind spot vehicles/objects detection functionality, an optical camera connected to a video imaging display and/or audible devices within the vehicle are used in the same manner as the radar sensors. Information from the optical camera be used in addition or instead of radar sensor to inspect objects around the vehicle (vehicle captured by camera module, which has wide viewing angle more than 180-degrees). Additionally, the object detection functionality as same as or better than radar detection range earlier mentioned at lower cost by the use of an optical camera which utilizes artificial intelligence (AI) software that consist of an image pattern learning algorithm. This is all in one exterior unit which can be sealed and made watertight so it will be protected from the elements. It can also be easily removed when traditional towing is required. The entire unit utilizes power, ground and other items needed for the connection by way of the trailer hitch plug wiring. In this way the unit can be inserted in the trailer hitch receptacle and the wiring needed could be supplied by the trailer hitch plug used for the lighting and other items needed for towing thus requiring no additional installation of any kind. These wires can also be configured in a traditional manner if needed by direct connection. In using the trailer hitch and trailer wiring the installation can be done in a short period and can be removed quickly if needed for use in another vehicle. This exterior module can be secured by a traditional trailer lock that can be included or purchased separately for the vehicle.

A control module within that structure will process the information received from the sensors by way of a specifically designed processor and the unit can communicate this information via hardwire (FIG. 1). The indicators will relay the information to the driver visually and/or audibly. The exterior control unit containing the sensors and processor can also house a camera that can aid while the vehicle is in reverse or provide useful information to the driver if needed. The video images are also connected to a second controller within the vehicle in the same manner as the information from various sensors.

A second embodiment is designed for many conventional vehicles equipped with a standard license plate using a bar like assembly at the rear end of the vehicle. The location of the rear license plate makes it optimum for a high frequency radar based blind spot detection system. The license plate bar is added on top of a prefabricated license plate frame, the bar containing the necessary sensors and electronics required to complete the sensing portion of the system. The sensors are purposely placed at the rear of the vehicle in a position that is not obstructed by any vehicle parts. The first component of the system 99 (FIG. 4) is a high frequency or radar-based sensor configuration that is purposely built into a standard license plate bar type structure. These are typically standard size making them universal in most cases or very adaptable to all vehicles. The system has one or two sensors placed near the center of a vehicle that provides the best coverage for blind spot detection. Since the sensors are already mounted and accurately placed, they can be mounted very quickly by installing over the standard license plate frame. Thus, no angle adjustment or calibration process is necessary for accurately aiming the angle of sensors for optimum detection by installation professionals. This offers many benefits as the sensors are already installed at the correct placement angle, they are prewired to the control interface within the mounting structure and avoids the potential interfering body parts of the vehicle. The installation takes place by securing the bar over the standard license plate frame. As can be seen in FIGS. 4A and 4B, this embodiment is independent from the vehicle license frame, thus the owner of the vehicle can retain the original license plate frame. This is all in one exterior unit that can be sealed and made watertight so it will be protected from the elements. The entire unit utilizes ground and other items needed for the connection by way of internal trunk wiring accessible within the area of the installation. In this manner the license plate bar can be added and all the connections necessary is found in or around that location. These wires can be connected in a traditional manner if needed by direct connection within the interior of the vehicle. This exterior bar module can be secured by means of security fasteners or screws that would prevent theft of the exterior sensor unit.

A third embodiment of the present invention utilizes the third brake light on many commercial vans that have limited vision on each side due to the lack of windows and blind spots because of the large side areas. This embodiment has all the components of the blind spot system built into a third upper mounted brake light that is common for these vehicles. The factory installed brake light without the blind spot and sensing capability is replaced with an identical mounted unit with the blind spot sensing capability built in. This system utilizes existing wiring thus allowing for a less difficult installation while retaining an original equipment look.

The first component of the system is a high frequency or radar-based sensor configuration that is purposely built on a third brake light housing. The system has a single radar sensor (additional sensors can be used) placed in a manner that provides the best coverage for blind spot detection. Since these sensors are already mounted and accurately placed, they can be mounted very quickly by being attached to the light structure. This offers many benefits as the sensors are already installed at the correct placement angle, they are prewired to a control interface within the mounting structure, and they are beyond the potentially interfering body parts of the vehicle. A control module within the structure processes the information received from the sensors by way of a specifically designed processor and the unit can transmit this information by hardwire to a display device located within the vehicle. The secure connection will relay the information to the driver by visual and/or audible means. The exterior control unit containing the sensors and processor also has a camera that aids when the vehicle is in reverse or provides useful information to the driver if needed. The images would also be transmitted to a second controller within the vehicle in the same manner as the information from the sensors. The components noted hereinabove are mounted in one exterior unit which is sealed and made watertight so it will be protected from the elements. The entire unit utilizes power, ground and other needed connections by the way of the third brake light plug wiring. These wires can also be configured in a traditional manner if needed by direct connection.

The second controller that is common to all the systems noted above is mounted in the interior of the vehicle and acts as a display and audible speaker for communicating the information from the license plate bar to a vehicle driver, third brake light or trailer hitch mounted unit processing the information efficiently and accurately (as is well known, most, if not all, vehicles are made with two brake lights). It contains processors that deliver the information to the driver by any means necessary for the application desired. Information regarding vehicle presence detected by radar systems and cameras can be displayed on a TFT LCD video monitor screen mounted on a fixture or adhered to the dashboard using tape or connected to the monitor screen originally equipped in a vehicle via OEM interface hardwiring. The radar systems cover rearward blind spots of a vehicle, blind spots on both sides of the vehicle to detect moving or stopper objects. The controller can be fashioned to connect directly to the OBDII data port of the vehicle that could provide working power, ground, ignition ON power as well as other useful information that such as vehicle speed, engine and transmission state. By using utilizing the OBDII connection, little or no additional wiring or installation is needed for the system to operate. The system also uses the data available within the OBDII connection to communicate to the vehicles control module and both transmit and receive information through data from the vehicle directly. This information, along with other sensors such as GPS, can be used to limit operation of the system at very low speeds as well as retrieving information about turn indicator status or steering wheel position as well as all other available information on the central access network (CAN) of the vehicle.

Signaling in a visual or audible manner can be configured to operate through the factory equipment of the vehicle, a standalone lighting and/or attenuator or to another device via radio frequency transmission such as Bluetooth or Wi-Fi that can be a user's portable device such as a phone tablet, computer or other device installed within the vehicle.

### DESCRIPTION OF THE DRAWINGS

For a better understanding of the present invention as well as other objects and further features thereof, reference is made to the following description which is to be read in conjunction with the accompanying drawing wherein:

FIG. 1 is a block diagram of the basic analog/wired embodiment of the blind spot detection system of the present invention;

FIG. 2A illustrates a conventional trailer hitch and FIG. 2B illustrates the corresponding blind spot detection system with two sensors and a step;

FIG. 2C illustratethe blind spot system with one sensor mounted on trailer hitch with a step;

FIG. 2D to 2H illustrates various views 3-way view of the blind spot system with one sensor mounted on trailer hitch with a step;

FIG. 3A illustrates the blind spot system with one sensor mounted on trailer hitch without a step;

FIGS. 313 to 3D illustrates the blind spot system with one sensor mounted on trailer hitch without a step;

FIG. 4A illustrates a sensor bar positioned on a vehicle license plate frame;

FIG. 4B illustrates a modified sensor bar; and

FIG. 5 shows an application with the blind spot radar mounted at the location of a third brake light on a commercial van.

### DESCRIPTION OF THE INVENTION

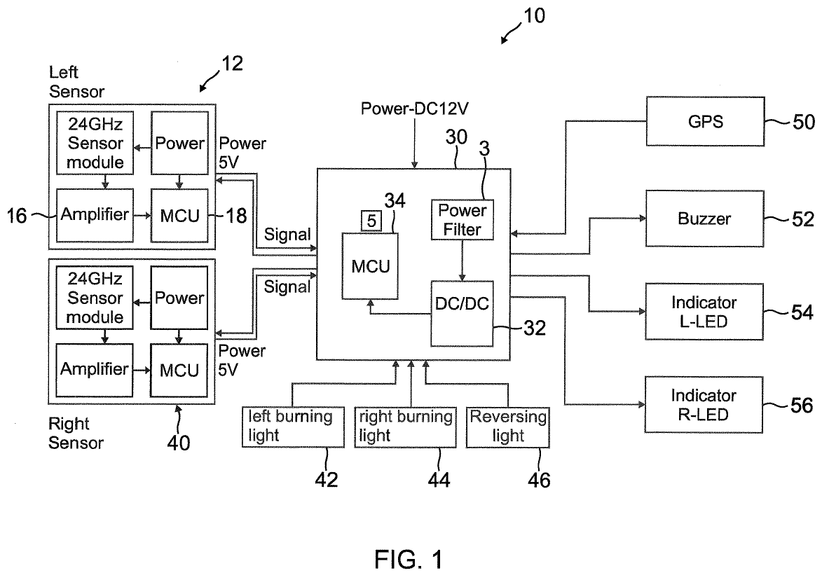

Referring to FIG. 1, a block diagram 10 of the blind spot detection system of the present invention is illustrated. The left microwave sensor unit 12 transmits and receives high frequency signals and interprets the resulting data through a signal amplifier 16 and a microcontroller 18 to determine the presence of a physical object within the sensing area of a microwave sensor 12 (microcontroller unit 18 controls the frequency timing and amplitude of the sensing signal and processes the results from each sensor). Microcontroller 18 is preferably the RSP1 radar processor manufactured by RFbeam Microwave Gmbh, St. Gallen, Switzerland. The high frequency signal is sent and received; the frequency shift created by the object and the time of the signals reception determines the presence of an object or vehicle as well as its closing rate. Sensor unit 12 is activated at a speed that is predetermined to help negate false reading at slow speeds where many items could be sensed (as in a parking lot). The resulting data is sent to the main processor 30 that contains circuitry including, but not limited to, a filter to ensure a clean power source, a voltage regulator 32 and the main processor module 34 (preferably a STM32F103 microprocessor manufactured by ST Microelectronics, Geneva, Switzerland).

The right sensor unit 40 operates in the same manner as sensor 12 and delivers information to the main processor unit 30. These are identical modules that are focused on the right and left side, respectively, for turning or changing lanes in that direction.

The main processor module 30 also receives information from various other inputs that will help determine how and when the unit will signal the vehicle driver. Turn indicator inputs 42 and 44 are used to show the drivers intentions in changing lanes and making turns where blind spot sensing is most important. An input 46 for indicating when the vehicle is in reverse is used to change the unit operation mode for backing up and sensing cross traffic that could be hard to see while exiting parking spots, for example: In this mode, both sensors are active at their maximum sensing range and the data from GPS 50 would be overlooked (a GPS antenna accurately detects speed) as this would occur at speeds lower than the threshold for normal forward motion. These inputs also determine when an audible alert is necessary. For instance, while driving in a straight direction the system could be programmed to always provide a visual alert, such as an LED light, when an object or vehicle is in the blind spot to assist the driver. But if the driver operates a turn indicator indicating the desire to turn or switch lanes, a visual alert (LEDs 54 and 56) and an audible alert (buzzer 52) is generated to indicate it is not safe and that an object or vehicle may be in the blind spot of the driver. In this scenario, the visual indication would always be on while the system is active and the vehicle is in motion sensing an object in the blind spot. The added audible alert would activate when the driver indicates a desire to turn or change lanes. This final audible alert would happen regardless of whether or not the driver sees the visual alert.

Processor unit 30 has other features that can be programmed by the user. Specifically, the user can adapt these settings for changing how the unit will operate depending on the type of vehicle and the desired results the specific user wishes to obtain. These programmable features include:
The minimum speed at which the unit will operate (GPS 50)
The duration of the visual alert signal (LED indicators 54 and 56) i.e., always on or only while the turn indicator is ON.
The audible attenuators actions (always on or only while the turn indicator is ON).
The volume and duration of the audible attenuator (buzzer) 52.
The sensing ranges of the high frequency microwave transceivers 12 and 40.

Processor unit 30 responds to the process signals received and delivers indicators based on the pre-determined setting that will alert the driver to objects, or vehicles, in the driver's blind spot. The processor 30 is typically placed within the interior of the vehicle and can be connected to the ODDII data connection, of the vehicle (ODBII refers to the diagnostic and recording capability of the vehicle) that would aid in, the installation of the controller and enabling a DIY type of installation by the user. The controller can also be connected in an analog manner for a fixed installation if required.

The left microwave sensor unit 12 transmits and receives high frequency signals and interprets the resulting data through signal amplifier. 16 and processor 18 to determine the presence of a physical object within the sensing area of microwave sensor 12. The high frequency signal-sent and received, and the frequency shift created by the object and the time of the signals reception determines the presence of an object or vehicle as well as its closing rate. This sensor unit 12 is activated at a speed that is predetermined to help negate false readings at slow speeds where many items could be sensed such as in a parking lot. The resulting data is sent to the main processor 30 that contains a filter to ensure a clean power source, a voltage regulator 32 and the main processor module 34 which contains a GPS receiver and logic predetermined for reliable operation.

The right sensor unit 40 operates in the same manner as sensor 12 and delivers information to the main processor unit 30. These are identical modules that are focused on the right and left side, respectively, for turning or changing lanes in that direction.

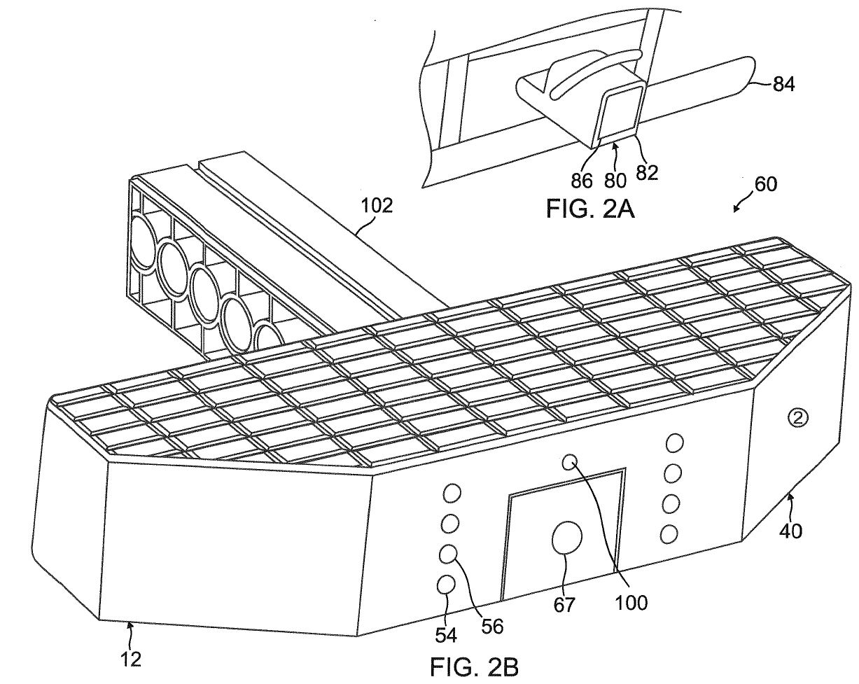

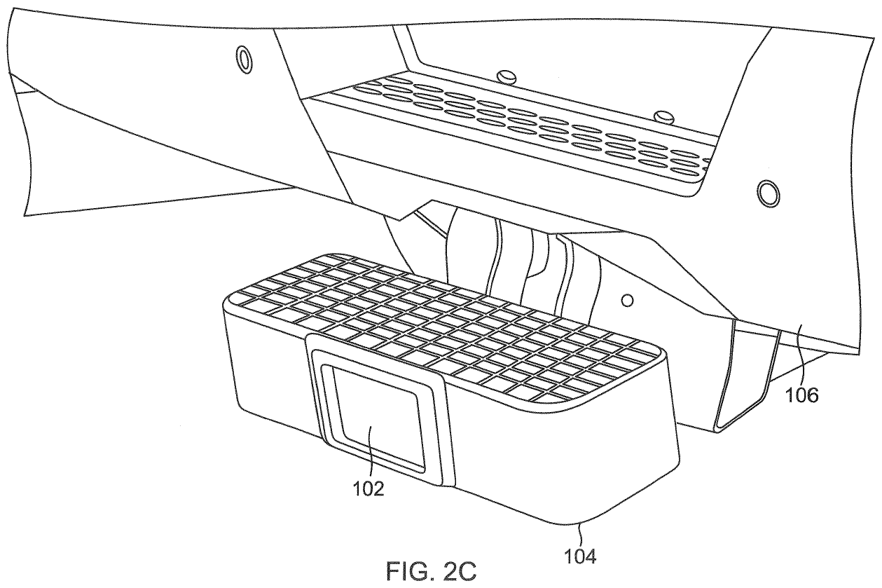

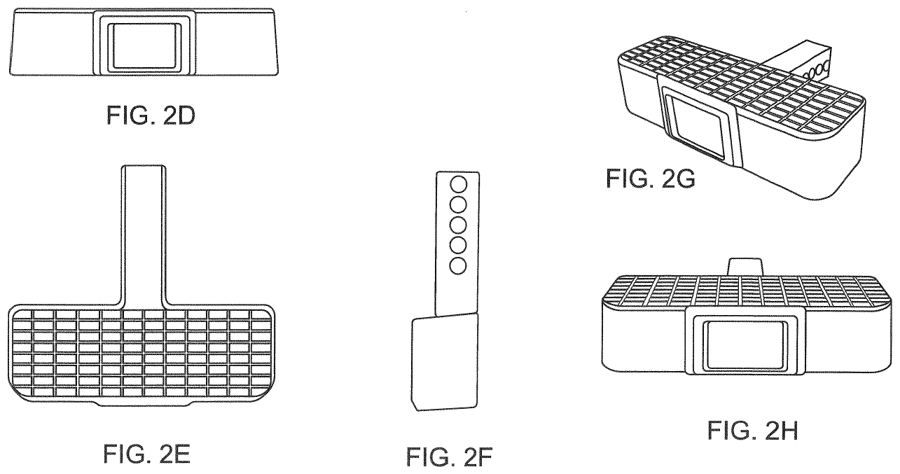

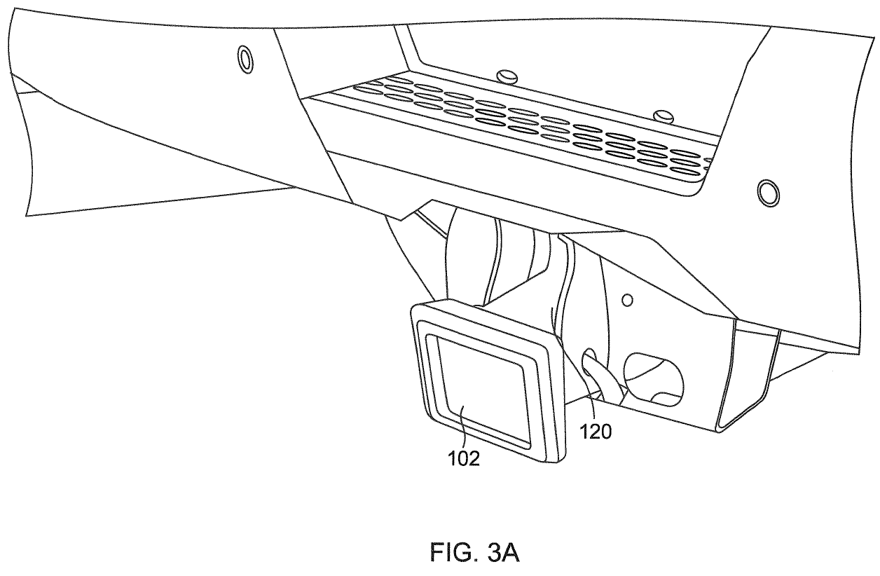

FIG. 2A illustrates a standard hitch 82 mounted to trailer 84 and trailer hitch assembly 60, shown in FIG. 2B, being positioned within an opening 86 of hitch 82 by inserting extension 102 therein and secured thereto with a lock (the various operating parameters of the trailer hitch assembly 60 are set by the user). The perspective view of assembly 60 shows left radar sensor 12, right radar sensor 40, rear video camera 67, LED indicator lights 54 and 56 and photosensor 100. Note that the trailer hitch assembly 60 can be used as a step for ease of entering or exiting the vehicle.

FIG. 2C illustrates a standard hitch blind spot system mounted on a trailer hitch with a bumper step 104 using a single radar sensor 102.

FIG. 2D is a front view of the bumper step 102, FIG. 2E a top view, FIG. 2F a side view and FIGS. 2G and 2H different perspective views of bumper step 104.

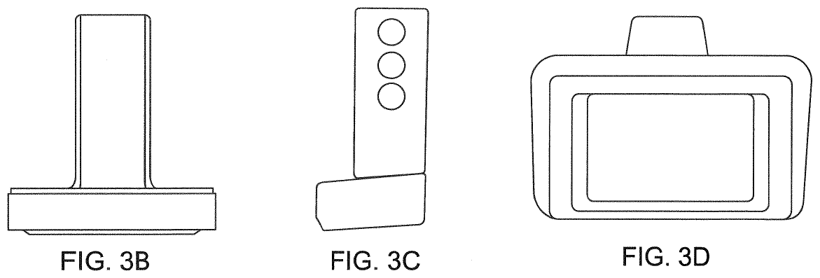

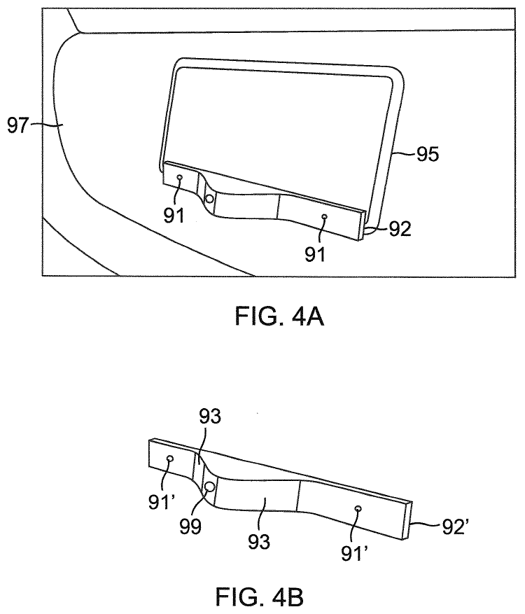

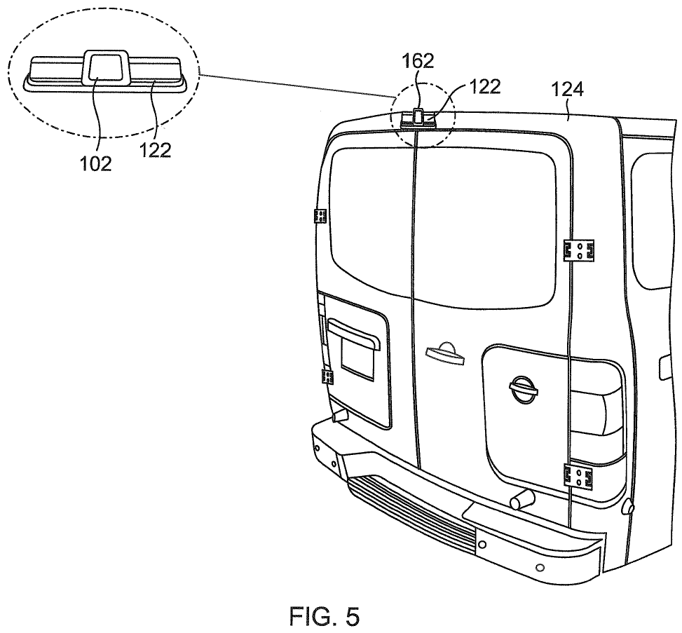

FIG. 3A illustrates a standard hitch blind spot system mounted on trailer hitch without a step.

FIG. 3B to 3D illustrates a various views of standard hitch blind spot system mounted on trailer hitch without a step.

FIG. 4 illustrates license plate bar 92 securely attached to a license plate 95 of vehicle 97, bar 92 incorporating the components of license plate assembly 70. Leads (not shown) for the power connection and ground from bar 92 are connected to the interior of the vehicle.

Processor 30 (FIG. 1) is located within the hitch and plate assemblies (FIGS. 2, 3 and 4, respectively) on the exterior of the vehicle.

The universality feature of the three blind side detection systems described above results from the fact that each version, once attached to a particular vehicle, can be removed and used with a different vehicle.

An improvement to the blind spot detection system shown in FIG. 0.2C utilizes one radar sensor instead of two. Referring to FIG. 2C, radar sensor 102 is shown embedded in bumper step 104. Sensor 102 monitors both passing and, approaching vehicles in the driver's blind spot. Sensor 102 is powered from the standard 9-pin trailer, plug originally equipped with the trailer 104 to which bumper step 104 is attached. Hitch step 104 can be removed when the driver, for, example, wants to tow a boat trailer. Sensor 102 has a 180-degree active viewing field and operates at 77 Ghz instead of the typical 24 Ghz which enables more data to be processed.

FIG. 2D is a front view of bumper, or hitch, step, FIG. 2E is atop view, FIG. 2F is a side view of bumper step 104, and FIG. 2H is a perspective view of the bumper step 104 with unit 102 installed therein.

FIG. 3A illustrates sensor unit 10 adjacent the vehicle rear junction box and not part of a bumper step. The radar sensor 102 is coupled directly to the standard electronics unit 120 available at the rear of vehicles.

FIG. 3B is a top view of sensor unit 102, FIG. 3C is a side view and FIG. 3D is a front view of radar sensor unit 102 which is coupled directly to the standard electronics available at the rear of vehicles.

FIG. 4A illustrates a sensor bar 92 positioned on vehicle license plate frame 95 used in conjunction with the blind spot detection system described in FIG. 1 and screws 91 used to fasten bar 92 to frame 95. FIG. 4B illustrates a modified, sensor bar 92′ having a hardwired camera 99, two blind spot sensors 93 and screw points 91′ to receive screws that fasten bar 92′ to an existing license plate frame.

FIG. 5 illustrates a third embodiment of the invention wherein the blind spot radar detection system 102 is mounted to the third brake light 122 of commercial van 124.

The system described in FIGS. 2-5 hereinabove also includes indicators mounted in the vehicle cabin which illuminate when a vehicle is detected in the detection zone. The corresponding indicator flashes when there is a vehicle in the detection zone while the driver turn signal is activated. An audible buzzer provides warning tones when a vehicle is in the detection zone.

A separate power button is provided to deactivate the system if an object is being towed behind the vehicle or if, there is cargo which obstructs the sensor.

While the invention has been described with reference to its preferred embodiments, it will be understood by those skilled in the art that various changes may be made, and equivalence may be substituted for elements thereof without departing from the true spirit and scope of the invention. In addition, many modifications may be made to adapt a particular situation or material to the teachings of the invention without departing from its essential teachings.

What is claimed is:

1. A high frequency vehicle blind spot detection system compromising at least one radar sensor, the system being configured to attach to an object at the rear of a vehicle.

2. The system of claim 1 wherein said object is a trailer hitch receptacle.

3. The system of claim 2 wherein said hitch receptacle has a step member attached thereto.

4. The system of claim 1 wherein said object is a license bar.

5. The system of claim 1 wherein said object is a brake light structure associated with said vehicle.

6. The system of claim 1 wherein said object is connected to existing vehicle electrical devices, said connections enabling said system to operate.

7. The system of claim 1 herein further including a camera for viewing the environment at the rear of said vehicle.

8. The system of claim 2 wherein aid system is removable from said object.

9. The system of claim 4 wherein said system is in the form of a bar member coupled to said license plate frame.

10. The system of claim 5 wherein said system is coupled to said brake light structure.

11. The system of claim 1 further including a camera for viewing the environment at the rear of said vehicle, the image captured by said camera being analyzed by artificial intelligence software.

12. The system of claim 11 wherein said bar member is mounted to the license plate frame at the rear of said vehicle.

13. The system of claim 12 wherein said vehicle includes a plurality of brake lights, said system being mounted to at least one of said brake lights.
